(19) United States
(12) Patent Application Publication
(10) Pub. No.: US 2005/0018060 A1
(43) Pub. Date: Jan. 27, 2005

(54) On-chip image processing

(76) Inventor: Isao Takayanagi, Tokyo (JP)

Correspondence Address: DICKSTEIN SHAPIRO MORIN & OSHINSKY LLP, 2101 L Street, NW, Washington, DC, 20037, US

(21) Appl. No.: 10/624,509

(22) Filed: Jul. 23, 2003

(51) Int. Cl. H04N 5/217

(52) U.S. Cl. 348/241

(57) ABSTRACT

Imaging circuits and associated methods implementing time-domain low-pass filter functionality on an imaging chip. An imager chip is disclosed, wherein the chip includes pixel and memory arrays, a data subtraction circuit, and image enhancement circuit and an analog-to-digital converter. Under an alternate embodiment, an averaging circuit is coupled between the pixel array and memory array. A unique pixel circuit and memory circuit are further disclosed for an imager system, wherein incoming signals are sampled and processed to remove noise components from the signal.

The present invention relates to imaging circuits and associated methods for implementing image processing on a chip.

### BACKGROUND OF THE INVENTION

Present imaging applications are requiring greater speeds to generate higher quality images. For example, two-dimensional binary pattern recognition applications, such as holographic memory pickup devices, require frame rates of several tens of thousands per second, using several hundreds of thousand pixels. When capturing images in such devices, the non-uniformity of illumination and optical shading of the pickup optics appear as unwanted background components in the captured image. As a result, undesirable shading patterns often appear in the image signal.

In order to control these background components, higher data resolutions of 6-8 bits are required in the image capturing to calibrate the shading in binary patterns. Assuming an image is being captured at a rate of 20 k frames per second (FPS), at 250 k pixels (500×500 pixels) having 8 bit resolution, the required output data rate of the imager becomes 40 G bits/s (or 5 G bytes/s). In order to realize such high frame rates, hundreds of output ports are required. Even at a 100 MHz clock rate, approximately 400 parallel output ports would be needed. Such a large number of output ports result in larger chip and package sizes and contribute to increased manufacturing costs.

### BRIEF SUMMARY OF THE INVENTION

The present invention relates to imaging circuits, and related methods that provide image processing, such as on-chip background component subtraction, thus allowing a smaller number of data output ports. Under one aspect of the invention, an imager chip is disclosed, having a pixel array and a memory array built into the chip, along with a data subtraction circuit, an image enhancement circuit and an analog-to-digital (A/D) converter. The chip operates to sample the image signal and the background component. Once stored, the background component can be subtracted from the image signal via the data subtraction circuit. The image enhancement circuit and the A/D converter then digitize the signal for external transmission. Under an alternate embodiment, an averaging circuit is coupled between the pixel array and the memory array to reduce time loss during the reading out of the background image.

A pixel circuit and a memory circuit are further disclosed, for receiving and storing the image signal and background component. Regarding the pixel circuit, a low-pass filter operation is built into the circuit for more effective subtraction operation in an imager. Likewise, the disclosed memory circuit performs the low-pass operation to allow compatibility with conventional pixels. An imager system is also disclosed, utilizing the pixel and memory circuits described above.

### BRIEF DESCRIPTION OF THE DRAWINGS

FIG. 1A is an exemplary graphic representation of a detected image output of a two-dimensional binary recode;

FIG. 1B illustrates initial black/white dot-coding on a memory disk;

FIG. 1C illustrates an exemplary signal component for an imaging device;

FIG. 2 is a process flow diagram with resulting image waves for extracting a signal component from an obtained image output;

FIG. 3 illustrates an exemplary 2-dimensional optical memory pickup device;

FIG. 4 illustrates an exemplary imager chip under an embodiment of the present invention, wherein the chip has a pixel and memory array, along with data subtraction, image enhancement, and analog-to-digital circuitry;

FIG. 5 illustrates an exemplary imager chip under an embodiment of the present invention, wherein the chip has a pixel and memory array, an averaging circuit, and data subtraction, image enhancement, and analog-to-digital circuitry;

FIG. 5A illustrates an exemplary output image from the imager chip of FIG. 5 averaged over multiple frames;

FIG. 6 illustrates an exemplary pixel circuit configured for performing an averaging operation on the imager chip of FIG. 5;

FIG. 7 is an exemplary graphical representation of the low-pass filtered pixel outputs using different filter coefficients;

FIG. 8 is a block diagram of an imager chip under another embodiment of the invention;

FIG. 9 is an exemplary timing diagram for the imager chip of FIG. 8;

FIG. 10 is a schematic diagram of an imager chip in another embodiment, wherein time-domain low-pass function is implemented in each memory cell;

FIG. 11 illustrates a configuration between each pixel unit and memory unit in the imager chip of FIG. 10;

FIG. 12 is an exemplary timing diagram for the circuitry described in FIGS. 10-11; and

FIG. 13 depicts a block diagram of a processor system employing an imager as in FIGS. 4-12.

### DETAILED DESCRIPTION OF THE INVENTION

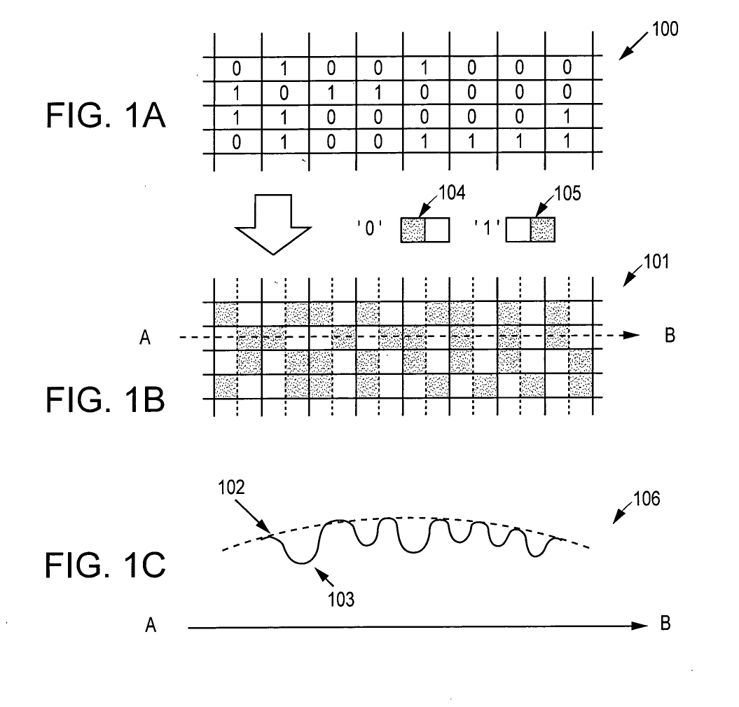

FIG. 1A illustrates an exemplary graphic representation of a detected image output of a two-dimensional binary recode 100, where data bits “1”and “0” are representative of the presence or absence of an image signal. Under a representation utilizing black-white dot pairs 104 and white-black dot pairs 105 for data “0” and “1” respectively, an initial coding on a memory disk can be obtained along a row line, shown as line A-B, in FIG. 1B. The resulting image waveform 106 is illustrated in FIG. 1C, where the waveform 106 is shown as having a signal component 103 and a background component 102. Background component 102 is typically shading that occurs in the imager output due to non-uniformities in lighting and optics pickup. Due to these reasons, along with the reflection limit of optics, resolution limit of the imager and contrast of dot pattern, the amplitude of the signal component often gets decreased as shown generally in FIG. 1C.

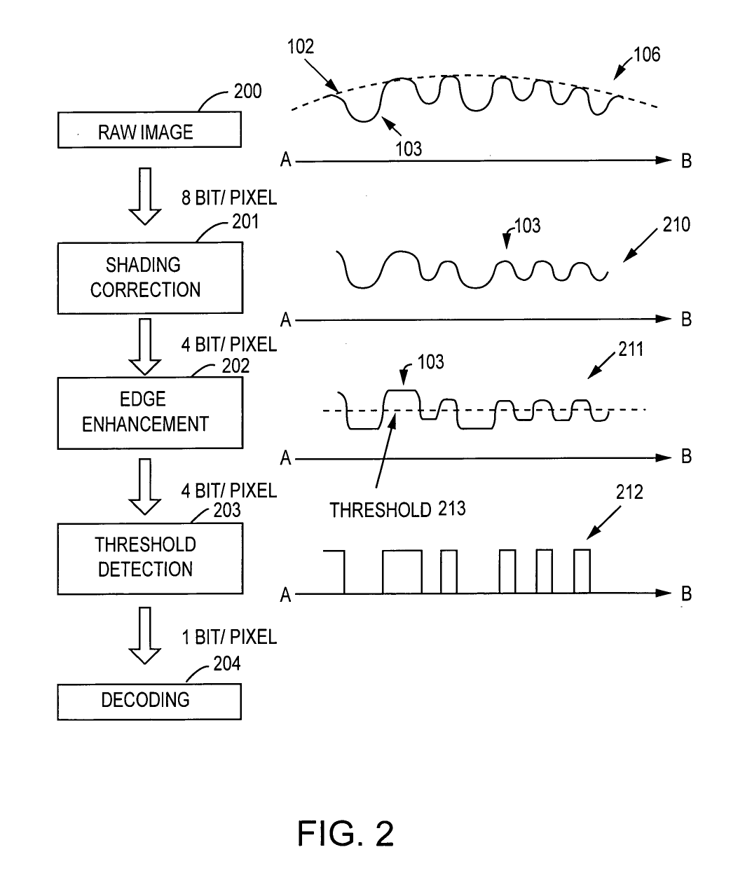

Turning to FIG. 2, an exemplary process flow and resulting image wave is illustrated for extracting a signal component from an obtained image output. In step 200, raw image data is obtained in the imaging system (also referred to as a “temporal” signal). In step 200, the image wave 106 has a signal component 103 and a background component 102 as discussed above in connection with FIG. 1C. Using 8 bit resolution per pixel under one embodiment, shading correction 201 is conducted on the image data, which removes the background component 102 from wave signal 103 as shown in waveform 210.

Next, using a reduced 4 bit resolution per pixel under one embodiment, an edge enhancement operation 202 is performed on the waveform, and a threshold point 213 is established for the waveform as illustrated in waveform 211. The resolution is reduced at step 202, since only the signal component remains. At step 203, threshold detection is performed on waveform 103 to acquire a binary data signal 212. Once acquired, the image is converted using 1 bit per pixel resolution and sent for decoding 204. It is understood that, while specific bit resolutions have been disclosed, other bit resolutions are equally applicable to the present invention. Furthermore, different configurations and spatial convolution may be used to perform spatial edge enhancement.

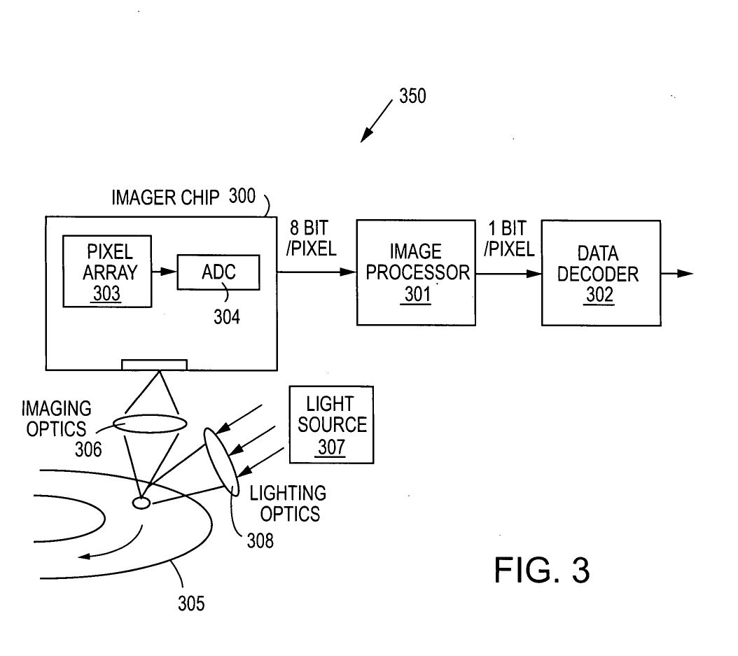

FIG. 3 shows a system, illustratively including a 2-dimensional optical memory pickup device 350, where a light source 307 provides light through lighting optics 308 onto an optical memory medium 305. Imager chip 300 receives an optical signal from optical memory medium 305 through imaging optics 306, whereupon the pixel array 303 within imager chip 300 converts the optical signal to charge carriers and integrates the charge carriers for read out of a current signal to analog-to-digital converter (ADC) 304. ADC 304 then provides a digital video signal, via 8 bit resolution per pixel, to the image processor 301. Image processor 301 then performs binary data conversion as described above in connection with FIG. 2, and the data decoder 302 extracts the stored data.

Under the architecture described in FIG. 3, the most apparent “bottleneck” in the data transport chain comes at the output of the imager chip 300, where the largest amounts of data are typically transferred. By implementing image processing functions on the imager chip 300, these “bottlenecks” can be minimized.

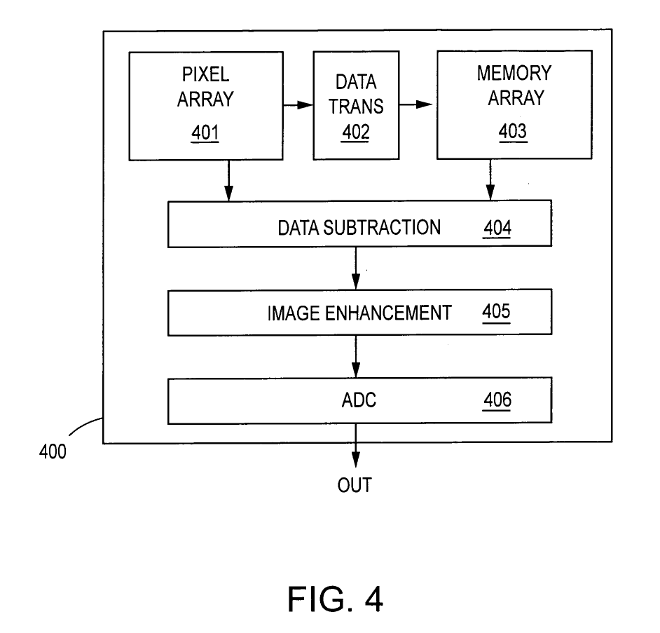

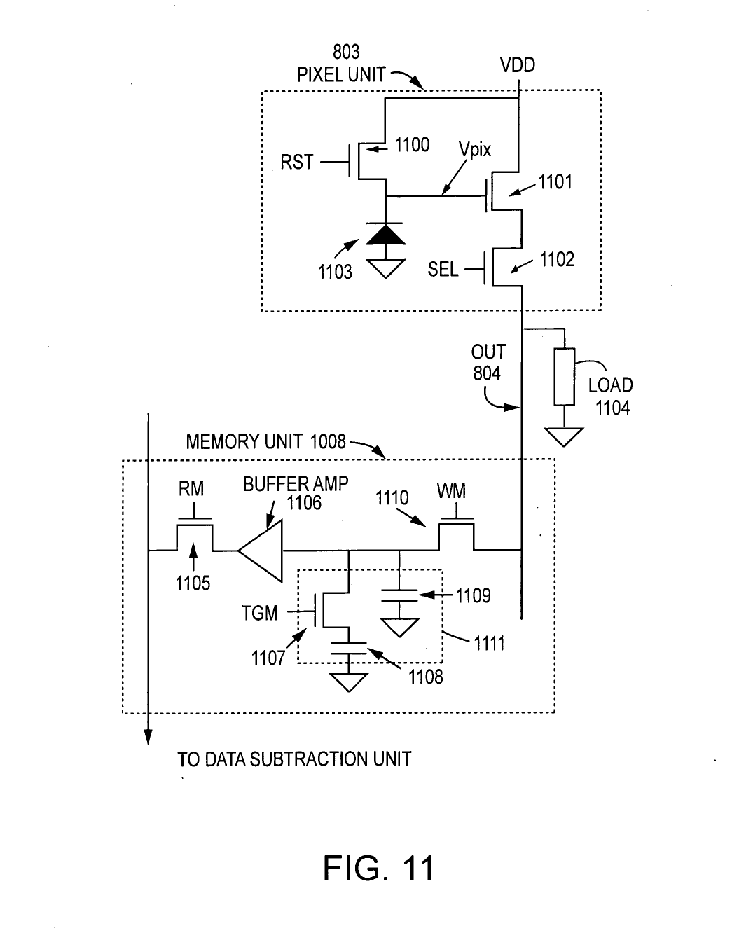

FIG. 4 illustrates an exemplary embodiment of such an imager chip 400 formed on a substrate, which comprises a pixel array 401 and a memory array 403, wherein memory cells (not shown) in the memory array 403 correspond to respective pixels (not shown) in pixel array 401. Pixel array 401 can be a conventional imaging array or equivalent circuitry. Memory array 403 can be implemented with circuitry similar to memory unit 100 in FIG. 11, described below. Data transfer control block 402, which could be implemented with conventional circuitry, facilitates the transfer of data between the pixel array 401 and memory array 403 and further controls data sampling timing.

As a readout operation begins, a background image is first read out from a “no data” area of the memory disk 305. The read out image data is then transferred from the pixel array 401 to the memory array 403 via the data transfer block 402. The memory array 403 then stores the optical shading or fixed-pattern noise as a background signal component. After this operation is completed, an actual disk scan operation is started, and a signal component is obtained.

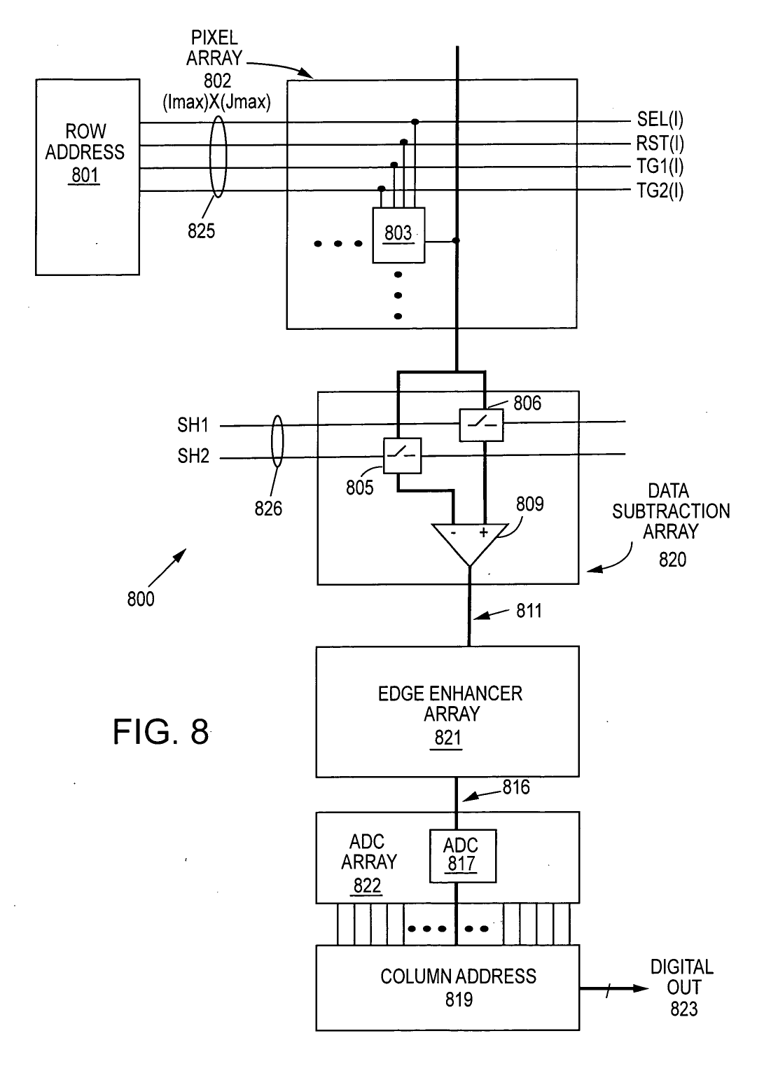

After obtaining the signal component and the background component, data subtraction block 404 performs subtraction of the background image from the signal component of the image to suppress offset variations caused by any shading or fixed pattern noise from the optics, or from other sources. Subtraction between values from pixel array 401 and memory array 403 can be performed by circuitry similar to data subtraction array 820, in FIG. 8, described below. The signal component is then transferred to image enhancement block 405 which enhances edges on the signal. One example of edge enhancement is discussed in Takayanagi, et al., “A Multiple Output CMD Imager for Real-Time Image Processing”, IEDM Tech. Digest, p. 579-582 (1993).

The ADC block 406 converts the edge-enhanced signal into a digital video signal and outputs the signal from the imager chip 400. Since the signal outputted from imager chip 400 has been preprocessed with edge-enhancement, only low data resolution is required in the ADC operation. Thus, if only binary data is necessary for the decoding process, the ADC 406 block may be replaced by a simple comparator circuit.

By using the configuration illustrated in the exemplary embodiment of FIG. 4, the data resolution for the ADC block 406 may be effectively reduced, as well as the total required data rate for the imager. Additionally, the lowered ADC bit resolution translates also into power reduction of the ADC, which in turn allows the ADC to perform at higher speeds.

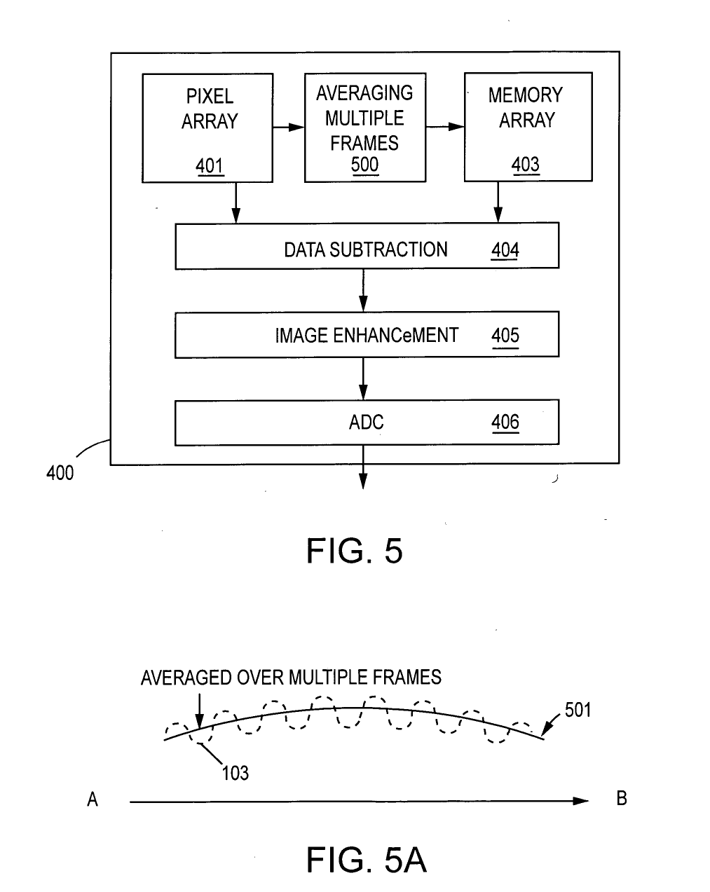

Turning to FIG. 5, an alternate embodiment is disclosed, wherein the data transfer block 402 of FIG. 4 is replaced by averaging multiple frame circuit 500. During the background image readout period, the data extraction process is usually interrupted to move the pickup head of the imager to a reference point on the disk, where no data is recorded. This interruption results in time loss, which affects the overall system performance. Accordingly, the averaging multiple frame circuit 500 in imager chip 400 operates to reduce or eliminate time loss due to the reading out of the background image and can be implemented with an integrator or averaging capacitor or other conventional circuitry.

FIG. 5A illustrates an output image 103 averaged over multiple frames, wherein the averaged output 501 closes to a half-level which bisects the peak points of image signal 103. Assuming that the data memorized on a disk consists of equal parts white and black parts (see FIG. 1B above), the averaged occupying ratio of a black or white area effectively becomes 50%. Since only the shading component is contained in the averaged image, the averaged frame can be used as a background image. The averaging multiple frame block 500 averages each pixel from pixel array 401 individually over multiple frames. The averaged image is subsequently stored in the memory array 403. An additional advantage of the embodiment of FIG. 5 is that the imager becomes free from refreshing the background image—accordingly, continuous operation can be realized for the imager.

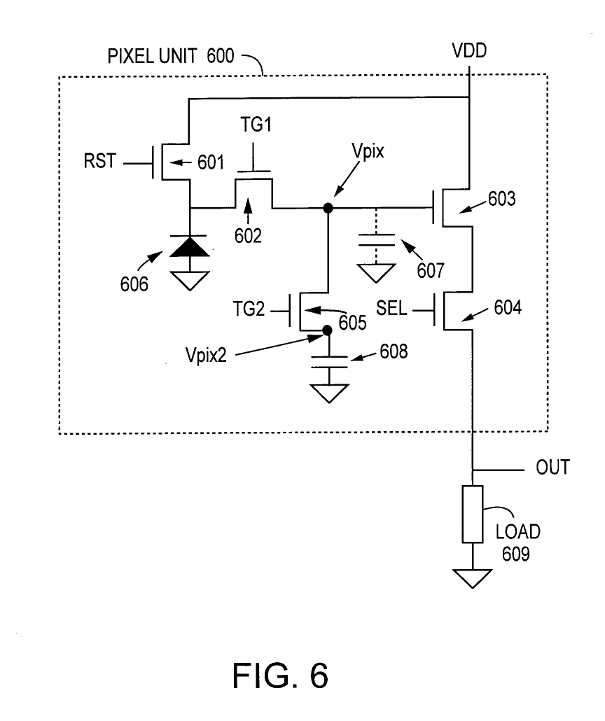

Turning to FIG. 6, a third embodiment is disclosed, illustrating an exemplary pixel circuit 600 configured for performing the averaging operation described above. Pixel circuit 600 is comprised of reset transistor 601, having a drain terminal coupled to the operating voltage V_{DD}, and a source terminal coupled to photodiode 606, and further to the source terminal of a first transfer transistor 602. The gate terminal of reset transistor 601 receives a reset pulse from reset line (RST). Transfer transistor 602 has a first transfer pulse (TG1) line coupled to the base terminal, while having a drain terminal coupled to a first pixel node Vₚᵢₓ, as shown in FIG. 6. A second transfer transistor 605 receives a second transfer pulse (TG2) at its gate terminal, and has a source terminal coupled to the first pixel node Vₚᵢₓ, and also has a drain terminal coupled to a second pixel node Vₚᵢₓ₂. Pixel node Vₚᵢₓ₂ is coupled to averaging capacitor 608, which is further coupled to ground.

Pixel node Vₚᵢₓ is also coupled to pixel capacitor 607, and to a gate terminal of readout transistor 603. The drain terminal of readout transistor 603 is coupled to the operating voltage V_{DD} line, and the source terminal of readout transistor 603 is coupled to the drain terminal of select transistor 604. The gate terminal of select transistor 604 is coupled to the SEL line, and the source terminal of select transistor 604 is coupled to a load circuit 609 and output line (OUT) that are outside of the pixel array.

During operation under the exemplary embodiment, a RST pulse is applied to the gate terminal of reset transistor 601 when the first transfer transistor 602 is ON and the second transfer transistor 605 is OFF. After the reset pulse RST is applied, the integration period for the pixel circuit begins, where charge (Vₚᵢₓ) is accumulated on photodiode 606. Once the integration period ends, SEL pulse turns transistor 604 on and transfer transistor 602 turns off to hold the accumulated voltage at the Vₚᵢₓ node. The output voltage at the output node (OUT) can be expressed as:
V_{pix(OUT)}=G_{SF}×(V_{pix(RST)}−ΔVₚᵢₓ) (1)
where G_{SF} denotes the voltage gain of the source-follower circuit, V_{pix(RST)} is the reset voltage, and ΔVₚᵢₓ is the difference in voltage between a temporal Vₚᵢₓ and V_{pix(RST)}.

After the photo signal Vₚᵢₓ, is read out through the source follower circuit, the second transfer pulse TG2 turns transistor 605 on for a short period, and then off again. Using the Vₚᵢₓ₂ voltage accumulated from capacitor 608, the filtered Vₚᵢₓ voltage may be expressed as:

$${V}_{pix ( filt )} = {V}_{pix2} = \frac{{C}_{A}}{{C}_{A} + {C}_{B}} {V}_{pix ( out )} + \frac{{C}_{B}}{{C}_{A} + {C}_{B}} {V}_{pix2 ( prior )} \qquad ( 2 )$$

where Vₚᵢₓ₂₍ₚᵣᵢₒᵣ₎ is the prior voltage of Vₚᵢₓ₂ just before TG2 is turned on, C_{A} is the capacitance of capacitor 607, and C_{B} is the capacitance of capacitor 608. Equation (2) expresses V_{pix(filt)} as a low-pass filtered output of Vₚᵢₓ, where the ratio of C_{B} to C_{A} determines the filter coefficient.

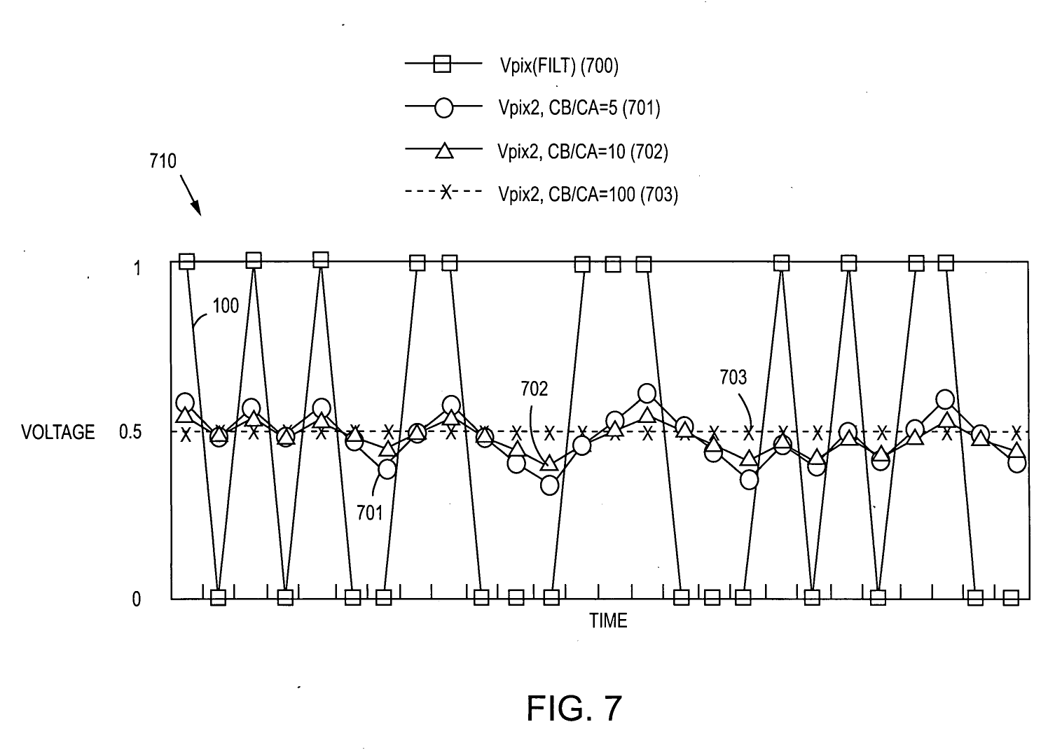

FIG. 7 illustrates an exemplary graphical representation 710 of the low-pass filtered output of V_{pix(filt)} and Vₚᵢₓ₂ under different filter coefficients. Graph 710 illustrates the different normalized voltages as they pertain to the temporal (time) frame series as shown in FIG. 7, with the response signals of Vₚᵢₓ₂ calculated using a C_{B}/C_{A} coefficient of 5 (shown as reference numeral 700), 10 (shown as reference numeral 702), and 100 (shown as reference numeral 703).

As can be seen in the exemplary embodiment of FIG. 7, the amplitude of temporal signal Vₚᵢₓ is always larger than the amplitude of Vₚᵢₓ₂. Subtraction of the low-pass signal Vₚᵢₓ₂ from the temporal signal Vₚᵢₓ occurs each time the temporal signal Vₚᵢₓ reaches a logic “high” level or a logic “low” level. The time constant of the low-pass filter increases as the ratio of C_{B}/C_{A} increases. Under one embodiment, if the maximum continuity of the binary dots is two, the averaged signal having a ratio of C_{B}/C_{A}=5 should be sufficient to use as an extracted background level. Other ratios can also be used as suggested in FIG. 7.

Turning to FIG. 8, a block diagram is disclosed of an imager chip under another embodiment of the invention. Imager 800 includes a pixel array 802 having [Iₘₐₓ(row)]×[Jₘₐₓ(column)] pixels, a row address circuit 801, a data subtraction array 820, an edge enhancer array 821, ADC array 822 and a digital readout 823. Row address circuit 801 outputs a row select pulse in addition to other control pulses SEL, RST, TG1 and TG2 for each row 825 of pixel array 802. Each output of each unit pixel 803 is connected in parallel to the data subtraction array 820 as shown in FIG. 8.

Data subtraction array 820 has two sample-and-hold lines 826 (SH1, SH2) that provide sampling pulses to sample-and-hold circuits 805, 806. The outputs of the sample-and-hold circuits 805, 806 are respectively coupled to the inverting and non-inverting inputs of differential amplifier 809. The output 811 of the differential amplifier 809 is then transmitted to edge enhancer array 821, where edge portions in the shading calibrated image are sharpened, described in relation to FIG. 4 above. The edge enhancer array 821 outputs an edge-enhanced data signal 816 for one row in parallel to a respective ADC circuit 817 in ADC array 822. The ADC array converts the edge-enhanced data to a digital signal and stores the digital signal in ADC memory (not shown). The digital data from the ADC is then selected by the column address block 819 and serially read out via digital readout lines 823.

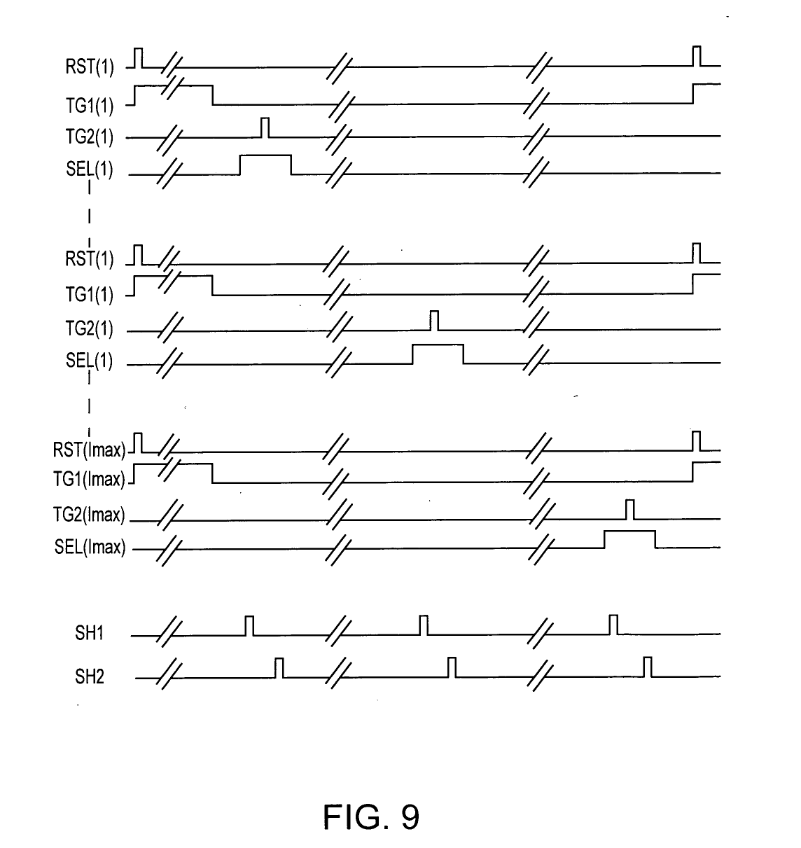

Turning to FIG. 9, an exemplary timing diagram is disclosed for the embodiment of FIG. 8. FIG. 9 shows the RST, TG1, TG2 and SEL pulses for each of the rows in pixel array 802, along with sample-and-hold pulses SH1 and SH2. First, the RST and TG1 pulses are turned on for each row simultaneously, thus resetting the Vₚᵢₓ voltages of all the pixels. After the RST pulse turns off, an integration period begins for each pixel.

After the integration period, a data scanning operation begins, where, for the first row, a SEL(1) pulse turns on and selects the first row line. Next, a sample-and-hold pulse sh1 goes high and stores the signal level in a sample-and-hold circuit. Once stored, pulse TG2 turns on briefly, and the time domain low-pass data is output at the OUT node, and sampled again when signal SH2 goes high. Subtracting the second sampled signal from the first sampled signal, via the differential amplifier, offset variations such as optical shading are suppressed, and the calibrated data is transferred to the edge enhancer array 821.

After the edge enhancement process and the A/D conversion, the data for one row is read out. After one row is read out, the process moves to the next row (TG2(I), SEL (I)), where the row cycle is repeated until the final row is reached (TG2(Iₘₐₓ), SEL (Iₘₐₓ)). When the final row is completed, the next frame operation is executed.

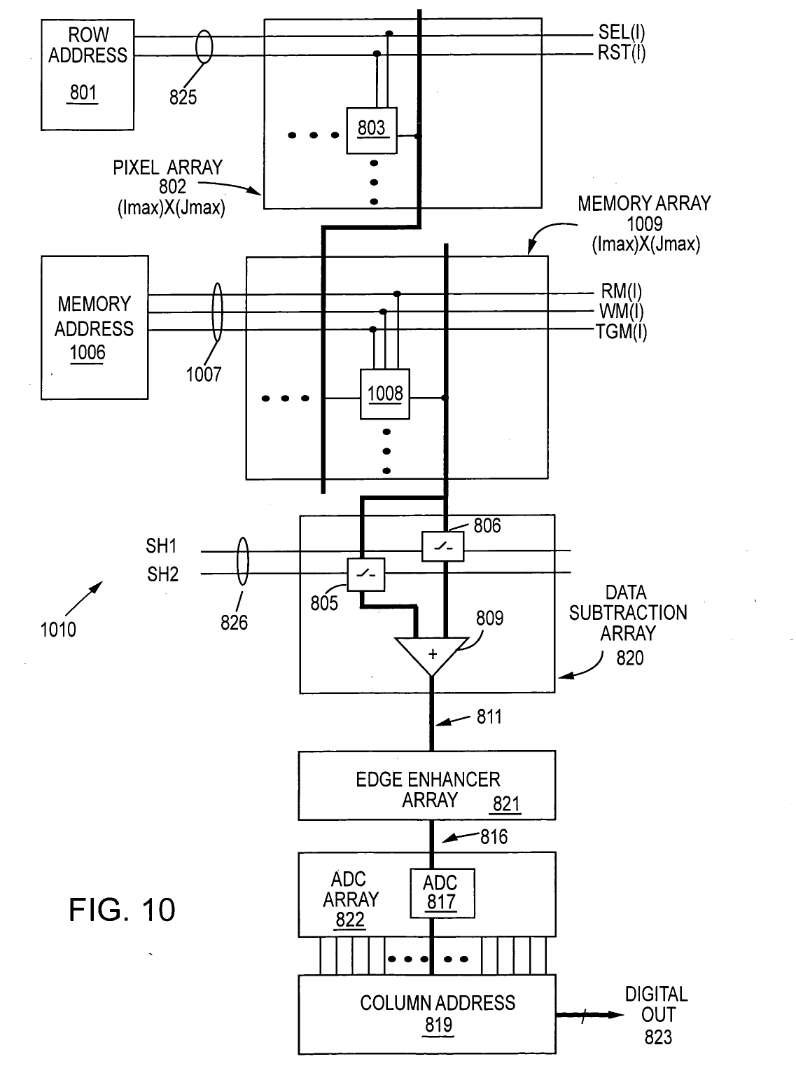

Turning to FIG. 10, yet another embodiment is disclosed, where the time-domain low-pass function is implemented in each memory cell in a memory array. To minimize the pixel size and to achieve a compact imaging area, the memory cell array and low-pass filtering circuits are located in the memory array. The embodiment of FIG. 10 is substantially similar to the embodiment of FIG. 8, except that transfer pulse lines TG1 and TG2 are removed from the row address 801, and a memory address block 1006 and memory array 1009 are added. Another feature of the FIG. 10 embodiment is that each memory cell 1008 of memory array 1009 has time domain low-pass functionality.

FIG. 11 illustrates in greater detail another configuration between each pixel unit 803 and memory unit 1008. The pixel 803 includes readout transistor 1101, reset transistor 1100, select transistor 1102 and photodiode 1103. It is understood that other pixel configurations (e.g., “4T”, “5T”) are equally applicable to the pixel unit 803. Memory unit 1008 is comprised of a read transistor 1105, a write transistor 1110, a transfer transistor 1107, memory capacitors 1108 and 1109, and a buffer amplifier 1106. The transfer transistor 1107, and memory capacitors 1108 and 1109 form the time domain filter 1111 that was discussed in the embodiments above.

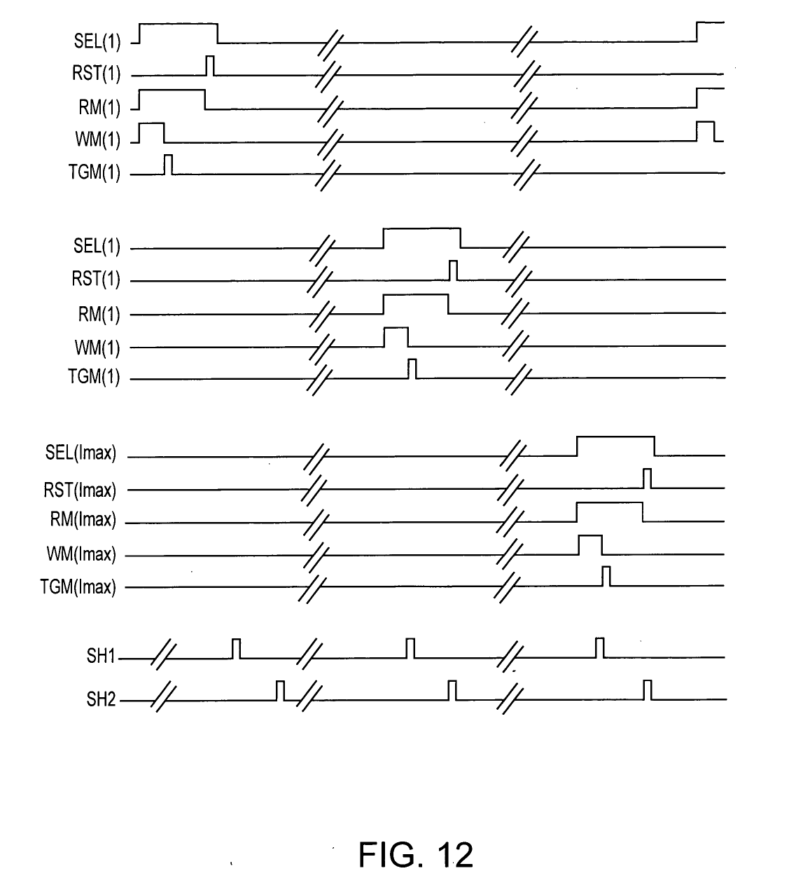

Turning to FIG. 12, an exemplary timing diagram is disclosed for the embodiment described in FIGS. 10-11. Similar to the timing diagram disclosed in FIG. 9, each of the control signals (SEL, RST, RM, WM and TGM) for each respective row are shown separately, with the sample-and-hold control signals sh1 and sh2 being shown at the bottom of FIG. 12.

Starting with the first row, select control signal SEL(1) goes high, transmitting the pixel signal for the first row to the memory cell array. At the same time, read control signal RM(1), and write control signal WM(1) are pulsed at the memory address block 1006, which outputs a memory cell buffered pixel signal V_{memsig}. At this point, sample-and-hold pulse SH1 goes high to sample the signal.

As the write control signal WM(1) goes low, transfer control signal TGM(1) goes high, forcing the signals stored in capacitors 1108 and 1109 to be combined. The combined signal is sampled as sample pulse SH2 goes high, and is output from the memory cell as a reference output, V_{memref}. The combined signal output may be expressed as the following equation:

$${V}_{memref ( i )} = \frac{CM1}{CM1 + CM2} {V}_{memsig ( i )} + \frac{CM2}{CM1 + CM2} {V}_{memref ( i - 1 )} \qquad ( 3 )$$

where CM1 represents the capacitance of capacitor 1109 and CM2 represents the capacitance of capacitor 1108, and the variable i represents each row number. Thus it can be seen that equation 3 possesses the same time-domain low-pass filtering in the memory array that was discussed above in connection with equation (2). As is shown in FIG. 12, the pixel output is read out once per frame period. Because the memory function is located outside the pixel array, a high aperture and/or smaller pixel can be used, even with a simple pixel configuration.

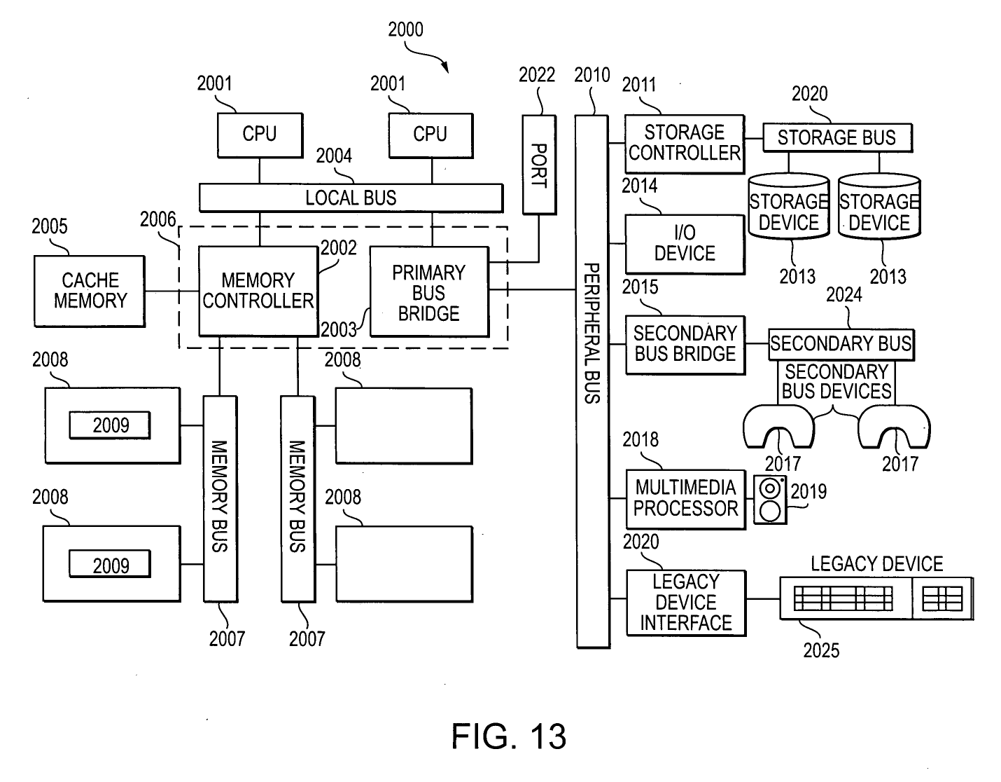

FIG. 13 illustrates an exemplary processing system 2000 which utilizes an imager chip such as that described in connection with FIGS. 1-12. The processing system 2000 includes one or more processors 2001 coupled to a local bus 2004. A memory controller 2002 and a primary bus bridge 2003 are also coupled the local bus 2004. The processing system 2000 may include multiple memory controllers 2002 and/or multiple primary bus bridges 2003. The memory controller 2002 and the primary bus bridge 2003 may be integrated as a single device 2006.

The memory controller 2002 is also coupled to one or more memory buses 2007. Each memory bus accepts memory components 2008. The memory components 2008 may be a memory card or a memory module. The memory components 2008 may include one or more additional devices 2009. For example, in a SIMM or DIMM, the additional device 2009 might be a configuration memory, such as a serial presence detect (SPD) memory.

The memory controller 2002 may also be coupled to a cache memory 2005. The cache memory 2005 may be the only cache memory in the processing system. Alternatively, other devices, for example, processors 2001 may also include cache memories, which may form a cache hierarchy with cache memory 2005. If the processing system 2000 include peripherals or controllers which are bus masters or which support direct memory access (DMA), the memory controller 2002 may implement a cache coherency protocol. If the memory controller 2002 is coupled to a plurality of memory buses 2007, each memory bus 2007 may be operated in parallel, or different address ranges may be mapped to different memory buses 2007.

The primary bus bridge 2003 is coupled to at least one peripheral bus 2010. Various devices, such as peripherals or additional bus bridges may be coupled to the peripheral bus 2010. These devices may include a storage controller 2011, a miscellaneous I/O device 2014, a secondary bus bridge 2015, a multimedia processor 2018, and a legacy device interface 2020. The primary bus bridge 2003 may also be coupled to one or more special purpose high speed ports 2022. In a personal computer, for example, the special purpose port might be the Accelerated Graphics Port (AGP), used to couple a high performance video card to the processing system 2000.

The storage controller 2011 couples one or more storage devices 2013, via a storage bus 2020, to the peripheral bus 2010. For example, the storage controller 2011 may be a SCSI controller and storage devices 2013 may be SCSI discs. The I/O device 2014 may be any sort of peripheral. For example, the I/O device 2014 may be an local area network interface, such as an Ethernet card. The secondary bus bridge 2015 may be used to interface additional devices via a secondary bus 2016 to the processing system. For example, the secondary bus bridge may be an universal serial port (USB) controller used to couple USB devices 2017 via to the processing system 2000. The multimedia processor 2018 may be a sound card, a video capture card, or any other type of media interface, which may also be coupled to one additional device such as speakers 2019. The legacy device interface 2020 is used to couple a legacy device(s) 2023, for example, older styled keyboards and mice, to the processing system 2000.

The processing system 2000 illustrated in FIG. 13 is only an exemplary processing system with which the invention may be used. While FIG. 13 illustrates a processing architecture especially suitable for a general purpose computer, such as a personal computer or a workstation, it should be recognized that well known modifications can be made to configure the processing system 2000 to become more suitable for use in a variety of applications. For example, many electronic devices which require processing may be implemented using a simpler architecture which relies on a CPU 2001 coupled to memory components 2008 and/or memory devices 2009. The modifications may include, for example, elimination of unnecessary components, addition of specialized devices or circuits, and/or integration of a plurality of devices.

While the invention has been described in detail in connection with embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention. It is understood that the system and circuit structures described in the embodiments above can substituted with equivalent system and circuit structures to perform the disclosed methods and processes. Accordingly, the invention is not limited by the foregoing description or drawings, but is only limited by the scope of the appended claims.

1. An imaging device, comprising:
a pixel array circuit that outputs an image signal and a background signal;
a memory array circuit, coupled to said pixel array circuit, said memory array circuit configurable to store an output from said pixel array; and
a data subtraction circuit, coupled to said memory array circuit and said pixel array circuit, said data subtraction circuit performing a data subtraction operation on the pixel array output to remove said background signal from said image signal.

2. The imaging device according to claim 1, wherein the imaging device further comprises an image enhancement circuit that performs an edge enhancement operation on the image signal received from the data subtraction circuit.

3. The imaging device according to claim 2, wherein the imaging device further comprises an analog-to-digital converter, which converts the signal received from the image enhancement circuit.

4. The imaging device according to claim 1, wherein each memory element in said memory array corresponds to a pixel circuit in said pixel array circuit.

5. The imaging device according to claim 1, wherein an averaging circuit is coupled between the pixel array and the memory array to average pixel array outputs over multiple frames.

6. A method for processing analog image data in an imager chip, said method comprising the steps of:
receiving image data, said analog image data including a background signal and a temporal signal;
performing a subtraction operation to separate the background signal from the temporal signal; and
performing an enhancement operation on the temporal signal to generate an edge-enhanced signal.

7. The method according to claim 6, wherein the analog image data is received from a pixel array in said imager chip.

8. The method according to claim 6, wherein said analog image data is received from a memory array in said imager chip.

9. The method according to claim 6, wherein the background signal comprises an offset variation signal.

10. The method according to claim 6, wherein the background signal comprises a fixed pattern noise signal.

11. The method according to claim 6, further comprising the step of performing an analog-to-digital conversion to the edge-enhanced signal in said imager chip.

12. A pixel circuit, comprising:
a photodiode, coupled to a reset node;
a first transfer transistor, said first transfer transistor having a source terminal coupled to the reset node, a gate terminal coupled to a first transfer voltage line, and a drain terminal coupled to an output voltage node;
a pixel capacitor, coupled to said output voltage node; and
a second transfer transistor, said second transfer transistor having a source terminal coupled to said output voltage node, a gate terminal coupled to a second transfer voltage line, and a drain terminal coupled to an averaging capacitor.

13. The pixel circuit according to claim 12, wherein said reset node is coupled to a drain terminal of a reset transistor, said reset transistor having a gate terminal coupled to a reset voltage line, and a source terminal coupled to an operating voltage.

14. The pixel circuit according to claim 12, wherein said output voltage node is coupled to a gate terminal of a readout transistor, said readout transistor further having a source terminal coupled to the operating voltage, and a drain terminal coupled to a source terminal of a select transistor.

15. The pixel circuit according to claim 14, wherein said select transistor further has a gate terminal coupled to a select voltage line, and a drain terminal coupled to a pixel output line.

16. The pixel circuit according to claim 15, further comprising a data subtraction circuit, coupled to the pixel output line.

17. The pixel circuit according to claim 16, further comprises an edge enhancement circuit that performs an edge enhancement operation on the image signal received from the data subtraction circuit.

18. The pixel circuit according to claim 17, further comprising an analog-to-digital circuit that converts the signal received from the edge enhancement circuit.

19. The pixel circuit according to claim 18, further comprising a column address circuit, coupled to said analog-to-digital circuit, said column address circuit having a digital output line.

20. A method of operating a pixel circuit, said method comprising the steps of:
generating and storing a pixel voltage;
generating and storing a signal voltage;
reading out said pixel voltage via a source-follower circuit; and
filtering said stored pixel and signal voltage in an analog domain to produce a low-pass filtered pixel voltage output.

21. The method according to claim 20, wherein the step of filtering comprises passing the pixel voltage and signal voltage through a capacitive filter.

22. The method according to claim 21, wherein the low-pass filtered pixel voltage output may be expressed as:
$$\frac{{C}_{A}}{{C}_{A} + {C}_{B}} {V}_{pix ( out )} + \frac{{C}_{B}}{{C}_{A} + {C}_{B}} {V}_{pix2}$$
wherein Vₚᵢₓ₍ₒᵤₜ₎ represents the pixel voltage, Vₚᵢₓ₂ represents the signal voltage, C_{A} represents a first capacitance associated with the pixel voltage in said capacitive filter, and C_{B} represents a second capacitance associated with the signal voltage in said capacitive filter.

23. The method according to claim 21, wherein a filter coefficient of said low-pass filtered pixel voltage output is C_{B}/C_{A}, wherein C_{A} represents a first capacitance associated with the pixel voltage in said capacitive filter, and C_{B} represents a second capacitance associated with the signal voltage in said capacitive filter.

24. The method according to claim 20, wherein the step of filtering further comprises subtracting the signal voltage from the pixel voltage.

25. An imager, comprising:
a row address circuit, said row address circuit having a plurality of control lines;
a pixel array, said pixel array comprising a plurality of pixel circuits, each of said plurality of pixel circuits being connected to said plurality of control lines and each pixel circuit having an output line;
a data subtraction array, said data subtraction array comprising a plurality of data subtraction circuits, each of said plurality of data subtraction circuits being coupled to a respective output line of said pixel circuit, and further being coupled to a first and second sample-and-hold line;
an edge enhancer array, said edge enhancer array comprising a plurality of edge-enhancement circuits, each of said edge enhancement circuits being coupled to a respective data subtraction circuit; and
an analog-to-digital converter array, said analog-to-digital converter array comprising a plurality of analog-to-digital converter circuits, each of said analog-to-digital converter circuits being coupled to a respective edge enhancement circuit.

26. The imager according to claim 25, wherein the control lines comprise a select line, a reset line, a first transfer line and a second transfer line.

27. The imager according to claim 25, wherein each pixel circuit comprises:
a photodiode, coupled to a resettable node;
a first transfer transistor, said first transfer transistor having a source terminal coupled to the resettable node, a gate terminal coupled to a first transfer voltage line, and a drain terminal coupled to an output voltage node;
a pixel capacitor, coupled to said output voltage node; and
a second transfer transistor, said second transfer transistor having a source terminal coupled to said output voltage node, a gate terminal coupled to a second transfer voltage line, and a drain terminal coupled to an averaging capacitor.

28. The imager of claim 25, wherein the data subtraction circuits comprise a first and second sample-and hold circuit, coupled respectively to the first and second sample-and-hold line, said first and second sample-and-hold circuits being further coupled to a differential amplifier.

29. A method of operating an imager, said method comprising the steps of:
accumulating photo current in parallel in each of a plurality of pixel circuits in a pixel array;
sequentially selecting row lines in said pixel array;
sampling a first voltage in each row line after it becomes selected;
outputting said first voltage from said selected row line;
sampling a second voltage present in said selected row line after the first voltage is outputted; and
subtracting said second voltage from said first voltage to obtain an analog filtered data signal for each selected row line.

30. The method according to claim 29, said method further comprising the step of performing an edge enhancement operation on each analog filtered data signal from each selected row line.

31. The method according to claim 29, wherein the steps of sampling the first and second voltages comprises storing the voltage in a capacitive element.

32. The method according to claim 29, wherein the step of subtracting the second voltage from the first voltage comprises transmitting both voltages through a differential amplifier.

33. An imager, comprising:
a row address circuit, said row address circuit having a plurality of control lines;
a pixel array, said pixel array comprising a plurality of pixel circuits, each of said plurality of pixel circuits being connected to said plurality of control lines and each pixel circuit having a pixel output line;
a memory address circuit, said memory address circuit having a plurality of memory control lines;
a memory array, said memory array comprising a plurality of memory circuits, each of said plurality of memory circuits being connected to said plurality of memory control lines and to a respective output line of a pixel circuit, each of said memory circuits having an memory output line;
a data subtraction array, said data subtraction array comprising a plurality of analog data subtraction circuits, each of said plurality of data subtraction circuits being coupled to a respective memory output line, and further being coupled to a first and second sample-and-hold line;
an edge enhancer array, said edge enhancer array comprising a plurality of analog edge-enhancement circuits, each of said edge enhancement circuits being coupled to a respective data subtraction circuit; and
an analog-to-digital converter array, said analog-to-digital converter array comprising a plurality of analog-to-digital converter circuits, each of said analog-to-digital converter circuits being coupled to a respective edge enhancement circuit.

34. The imager according to claim 33, wherein the control lines comprise a select line and a reset line.

35. The imager according to claim 33, wherein the memory control lines comprise a read line, a write line, and a transfer line.

36. The imager according to claim 33, wherein the memory circuits are further comprised of:
a first transistor, said first transistor being coupled to the pixel output line and to a voltage node;
a first capacitor, coupled between the voltage node and ground;
a second transistor, said second transistor being coupled to the voltage node and to a second capacitor, said second capacitor being further coupled to ground; and
a buffer amplifier, said buffer amplifier being coupled between the voltage node and a third transistor, said third transistor being further coupled to the memory output line.

37. The imager according to claim 36, wherein said first transistor has a gate terminal coupled to a write line, a source terminal coupled to the pixel output line, and a drain terminal coupled to the voltage node.

38. The imager according to claim 37, wherein said second transistor has a gate terminal coupled to said transfer line, a source terminal coupled to said voltage node, and a drain terminal coupled to said second capacitor.

39. The imager according to claim 38, wherein said third transistor has a gate terminal coupled to said read line, a source terminal coupled to said buffer amplifier, and a drain terminal coupled to the memory output line.

40. A method of operating an imager, said method comprising the steps of:
storing a buffered pixel signal;
receiving a row output of a row in a pixel array;
storing the output
accumulating photo current in parallel in each of a plurality of pixel circuits in a pixel array;
sequentially selecting each of a plurality of row lines in said pixel array;
storing a first analog voltage from a selected row line in a memory circuit;
transmitting said first analog voltage from said memory circuit to a data subtraction circuit;
receiving a second analog voltage from said selected row line after the first voltage is outputted; and
combining said first and second analog voltage and transmitting said combined voltage to a respective data subtraction circuit in a data subtraction array, each of said data subtraction circuit outputting a filtered data signal based on the first and second analog voltages.

41. The method according to claim 40, said method further comprising the step of performing an edge enhancement operation on each filtered data signal from each selected row line.

42. The method according to claim 40, wherein the steps of storing said first and second analog voltages comprises storing the voltage in a capacitive element.

43. The method according to claim 40, wherein the data subtraction circuit comprises differential amplifier.

44. A circuit for filtering an image, comprising:
a first transistor, said first transistor being coupled to an output line of a pixel circuit and a voltage node;
a first capacitor, said capacitor coupled between the voltage node and ground;
a second transistor, said second transistor being coupled to the voltage node and to a second capacitor, said second capacitor being further coupled to ground; and
a buffer amplifier, said buffer amplifier being coupled between the voltage node and a third transistor, said third transistor being further coupled to the memory output line.

45. The circuit according to claim 44, wherein said first transistor has a gate terminal coupled to a write line, a source terminal coupled to the pixel output line, and a drain terminal coupled to the voltage node.

46. The circuit according to claim 45, wherein said second transistor has a gate terminal coupled to said transfer line, a source terminal coupled to said voltage node, and a drain terminal coupled to said second capacitor.

47. The circuit according to claim 46, wherein said third transistor has a gate terminal coupled to said read line, a source terminal coupled to said buffer amplifier, and a drain terminal coupled to the memory output line.

48. An imager chip, comprising:
a substrate;
an array of pixel circuits formed in said substrate, each pixel circuit receiving light and, in response, providing a read out signal indicating light intensity;
processing circuitry, formed on substrate, said processing circuitry receiving readout signals from the array of pixel circuits and performing analog image processing on the readout signals; and
output circuitry, formed on the substrate, the output circuitry receiving processed readout signals from the processing circuitry, converting the processed readout signals to digital signals, and providing the digital signals as output from the imager chip.

49. The imager chip of claim 48, in which the processing circuitry performs at least one image processing operation from the set that includes background image subtraction and image enhancement.

50. A pixel circuit, comprising:
a light converting element that receives light and, in response, provides charge carriers;
a first capacitive element connected for receiving charge carriers from the light converting element, the first capacitive element storing a voltage indicating a quantity of charge carriers received;
a second capacitive element;
a switching element connected between the first and second capacitive elements and, when switched on, providing a conductive path through which a previous voltage stored by the second capacitive element is combined with the stored voltage from the first capacitive element; and
a readout element connected to provide a readout signal from the first capacitive element when the switching element is switched off and from the first and second capacitive elements when the switching element is switched on.

51. A memory circuit comprising:
an input lead for receiving a readout signal from a pixel circuit;
a first capacitive element connected to the input lead, the first capacitive element storing a voltage indicating a level of a received readout signal;
a second capacitive element;
a switching element connected between the first and second capacitive elements and, when switched on, providing a conductive path through which a previous voltage stored by the second capacitive element is combined with the stored voltage from the first capacitive element; and
a readout element connected to provide a readout signal from the first capacitive element when the switching element is switched off and from the first and second capacitive elements when the switching element is switched on.

52. A processing system, comprising:
a memory unit;
a processing circuit coupled to said memory unit, said processing circuit comprising:
a pixel array circuit that outputs an image signal and a background signal;
a memory array circuit, coupled to said pixel array circuit, said memory array circuit configurable to store an output from said pixel array; and
a data subtraction circuit, coupled to said memory array circuit and said pixel array circuit, said data subtraction circuit performing a data subtraction operation on the pixel array output to remove said background signal from said image signal.

53. The processing system according to claim 52, wherein the processing system further comprises an image enhancement circuit that performs an edge enhancement operation on the image signal received from the data subtraction circuit.

54. The processing system according to claim 53, wherein the processing system further comprises an analog-to-digital converter, which converts the output signal from the image enhancement circuit.

55. The processing system according to claim 52, wherein each memory element in said memory array corresponds to a pixel circuit in said pixel array circuit.

56. The processing system according to claim 52, wherein an averaging circuit is coupled between the pixel array and the memory array to average pixel array outputs over multiple frames.

57. An integrated circuit, comprising:
a substrate;
a pixel array circuit, formed in said substrate, for providing an image signal and a background signal;
a memory array circuit, formed in said substrate, coupled to said pixel array circuit for storing said image signal and background signal; and
a data subtraction circuit, formed in said substrate, coupled to said memory array circuit and said pixel array circuit, said data subtraction circuit performing a data subtraction operation to remove said background signal from said image signal.

58. The integrated circuit according to claim 57, wherein the integrated circuit further comprises an image enhancement circuit that performs an edge enhancement operation on the image signal received from the data subtraction circuit.

59. The integrated circuit according to claim 58, wherein the integrated circuit further comprises an analog-to-digital converter, which converts the signal output from the image enhancement circuit.

60. The integrated circuit according to claim 57, wherein each memory element in said memory array corresponds to a pixel circuit in said pixel array circuit.

61. The integrated circuit according to claim 57, wherein an averaging circuit is coupled between the pixel array and the memory array to average pixel array outputs over multiple frames.
